(19) United States
(12) Patent Application Publication
(10) Pub. No.: US 2004/0085511 A1
(43) Pub. Date: May 6, 2004

(54) Intraocular lens

(75) Inventors: Toshihiko Uno, Matsuyama-shi (JP); Yuichi Ohashi, Matsuyama-shi (JP)

Correspondence Address: OLIFF & BERRIDGE, PLC, P.O. BOX 19928, ALEXANDRIA, VA, 22320, US

(73) Assignee: NIDEK CO., LTD, GAMAGORI-SHI (JP)

(21) Appl. No.: 10/693,485

(22) Filed: Oct. 27, 2003

(30) Foreign Application Priority Data
Oct. 29, 2002 (JP) 2002-314533

(51) Int. Cl. G02C 7/04

(52) U.S. Cl. 351/160 R

(57) ABSTRACT

An intraocular lens which is placed between an iris and a crystalline lens, includes: an optical part which has a predetermined refractive power, the optical part being larger in diameter than a diameter of a pupil and including a fine pore formed through the optical part and arranged within a region centering an optical center of the optical part corresponding to a pupil area; and a support part which holds the optical part in an eye.

### BACKGROUND OF THE INVENTION

1. Field of the Invention

The present invention relates to an intraocular lens to be placed in a phakic eye for correcting a refractive power thereof.

2. Description of Related Art

There is known a method of correcting a refractive power of a patient's eye by placing an intraocular lens (which is also referred to as an intraocular contact lens) in an anterior chamber or a posterior chamber (between an iris and a crystalline lens) of the patient's eye. This method for refractive power correction by placing the intraocular lens in the posterior chamber has disadvantages that the intraocular lens when placed in the posterior chamber, in some cases, makes direct contact with a normal crystalline lens and/or prevents aqueous humor made in or around a ciliary body from sufficiently flowing in the posterior chamber including the front surface (facing the iris) of the crystalline lens and the anterior chamber.

To avoid the above disadvantages, a method of producing an intraocular lens by forming a plurality of holes in an intraocular lens material to allow the passage of nutrients and fluids is known (for example, Japanese patent unexamined publication No. Hei 8-510661 (corresponding to PCT/US93/04967)). Moreover, an intraocular lens formed with recesses and through holes in an outer periphery of an optical part to reduce a contact area with the crystalline lens and not to prevent the flow of aqueous humor is known (for example, Japanese patent unexamined publication No. 2002-177306).

The former discloses the formation of holes in the intraocular lens material for allowing nutrients and fluids to pass through the holes; however, it does not disclose the structure to reduce a contact area with the crystalline lens when the intraocular lens is placed in the posterior chamber nor the structure to allow the aqueous humor to sufficiently flow in the posterior chamber including the front surface of the crystalline lens and the anterior chamber.

According to the latter, the contact area with the crystalline lens is reduced; however, the through holes being formed outside the optical part might be blocked up by the iris. This makes it difficult to allow the aqueous humor to sufficiently flow in the posterior chamber including the front surface of the crystalline lens and the anterior chamber.

### SUMMARY OF THE INVENTION

The present invention has been made in view of the above circumstances and has an object to overcome the above problems and to provide an intraocular lens which allows aqueous humor to sufficiently flow in a posterior chamber including the front surface of a crystalline lens and an anterior chamber.

Another object of the present invention is providing an intraocular lens adapted to reduce a contact area with a crystalline lens.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided an intraocular lens which is placed between an iris and a crystalline lens, the intraocular lens including: an optical part which has a predetermined refractive power, the optical part being larger in diameter than a diameter of a pupil and including a fine pore which is formed through the optical part and arranged within a region centering an optical center of the optical part corresponding to a pupil area; and a support part which holds the optical part in an eye.

According to another aspect of the invention, there is provided an intraocular lens which is placed between an iris and a crystalline lens, the intraocular lens including: an optical part which has a predetermined refractive power, the optical part being larger in diameter than a diameter of a pupil and including a fine pore which is formed through the optical part and arranged within a region centering an optical center of the optical part corresponding to a pupil area, and the fine pore being of an inner diameter determined to allow aqueous humor to pass therethrough and maintain optical characteristics of the optical part; and a support part which holds the optical part in an eye.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1A is a plan view of an intraocular lens in a present embodiment;

FIG. 1B is a sectional view of the intraocular lens of FIG. 1A;

FIG. 2 is a sectional view of the intraocular lens placed in an eye;

FIG. 3A is a plan view of an intraocular lens in another embodiment; and

FIG. 3B is a sectional view of the intraocular lens of FIG. 3A.

### DETAILED DESCRIPTION OF THE PREFERRED EMBODIMENTS

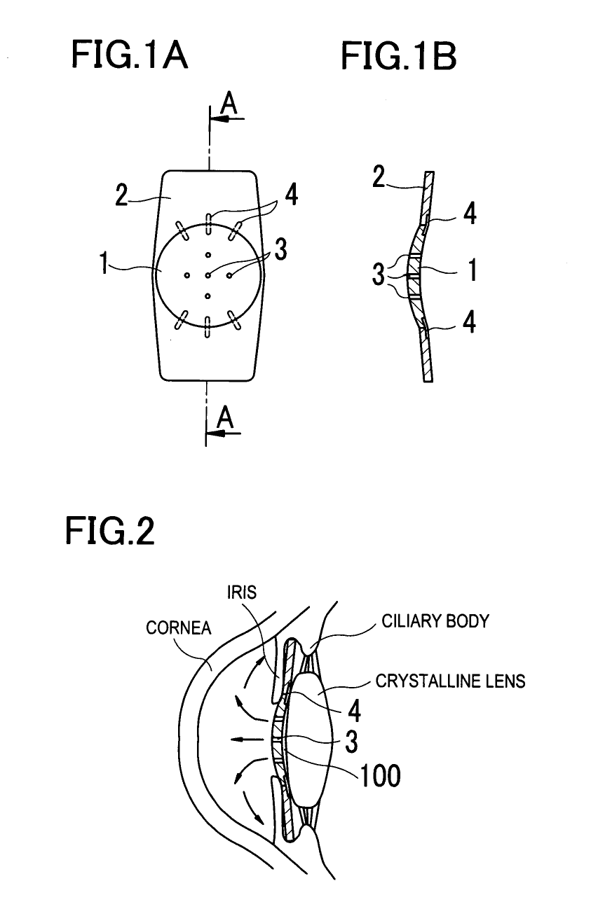

A detailed description of a preferred embodiment of an intraocular lens embodying the present invention will now be given referring to the accompanying drawings. FIG. 1A is a plan view of the intraocular lens in the present embodiment and FIG. 1B is a sectional view of the intraocular lens taken along the line A-A in FIG. 1A.

Numeral 1 is an optical part of the intraocular lens having a predetermined refractive power. Numeral 2 is a support part serving to hold the optical part 1 in an eye. The optical part 1 and the support part 2 may be made of either hard materials such as PMMA (polymethylmethacrylate) or soft foldable materials such as silicone, HEMA (hydroxyethylmethacrylate), and composites of acrylic ester and methacrylic ester.

The optical part 1 is of a meniscus shape as shown in FIG. 1B. The back surface of the optical part 1, namely, the surface facing a crystalline lens when the intraocular lens is placed in the eye, has a larger curvature (curve) than that of the front surface of the crystalline lens. This is to prevent the center and its vicinity of the back surface of the optical part 1 from coming into contact with the center and its vicinity of the front surface of the crystalline lens when the intraocular lens is placed in the posterior chamber (between an iris and the crystalline lens) (see FIG. 2). The optical part 1 is designed to have a larger diameter (about 4 to 7 mm) than that of a pupil defined by the iris. Thus, the pupil diameter will not exceed the diameter of the optical part 1 even when the pupil is dilated in daily life, thereby suppressing the generation of glares in the night.

The optical part 1 is formed with fine pores (through holes) 3 for allowing aqueous humor made in or around a ciliary body (or a ciliary process) to sufficiently flow in the posterior chamber including the front surface of the crystalline lens and the anterior chamber. The fine pores 3 are arranged within a region centering on an optical center of the optical part 1 corresponding to the pupil area, preferably, arranged in the vicinity of the center of the optical part 1. It is to be noted that five fine pores 3 are provided in FIG. 1A, but the number of fine pores 3 is not limited thereto and may be one or more than five.

An inner diameter of each fine pore 3 has to be determined to allow the aqueous humor to pass therethrough and not to deteriorate the optical characteristics (optical functions) of the optical part 1. Thus, the inner diameter of each fine pore 3 is preferably on the order of 0.01 μm to 1.0 mm, more preferably on the order of 0.1 μm to 0.1 mm. In the case of an inner diameter of less than 0.01 μm, pores 3 will be hard to form. In the case of an inner diameter of more than 1.0 mm, pores 3 may reduce the optical characteristics of the optical part 1. This reduction in the optical characteristics means a decrease in the lens performance which would be caused, for example, when the light incident on the optical part 1 is partially reflected by edges of the pores 3.

The optical part 1 with such pores 3 is produced by simply making the pores 3 by means of a microdrill or the like after production of the optical part 1. To produce the optical part 1 with the fine pores 3 each having an inner diameter of less than 0.1 mm, furthermore, a rod-shaped material (an intraocular lens material) to be used for production of the optical part 1 is processed to make pores and drawn along the longitudinal direction thereof, and then processed by a conventional cutting technique for intraocular lenses. In this way, the optical part 1 with fine pores 3 each having a smaller inner diameter can be produced.

On the back surface of the intraocular lens, a single or a plurality of grooves (six grooves 4 in the present embodiment) are formed to allow the aqueous humor to flow to the center and its vicinity of the front surface of the crystalline lens. Specifically, the grooves 4 each have a predetermined size (width and length) and are radially arranged in circumferentially spaced relation in a portion which will make contact with the crystalline lens when the intraocular lens is placed in the posterior chamber, so that the aqueous humor is allowed to flow toward the fine pores 3. The grooves 4 in the present embodiment are formed in the boundary between the optical part 1 and the support part 2, but not limited thereto. Through such grooves 4, the aqueous humor is allowed to flow to the center and its vicinity of the front surface of the crystalline lens. Furthermore, the contact area of the intraocular lens with the crystalline lens can be reduced.

It is to be noted that the grooves 4 does not need to be formed in the case that the intraocular lens will not contact the crystalline lens or the aqueous humor is allowed to flow to the center and its vicinity of the front surface of the crystalline lens even if the intraocular lens is in contact with the crystalline lens (in other words, the intraocular lens is in partial contact with the crystalline lens, thus providing noncontact portions through which the aqueous humor is allowed to flow to the center and its vicinity of the front surface of the crystalline lens).

An example of the intraocular lens of FIG. 1 being placed in an eye is explained below.

The intraocular lens in the present embodiment is placed in the posterior chamber (between the iris and the crystalline lens) in order to correct the refractive power of a patient's eye. As shown in FIG. 2, the support part 2 of this intraocular lens is inserted in ciliary grooves to fixedly hold the optical part 1 in place. When the intraocular lens in the present embodiment having the aforementioned meniscus shape is placed in the posterior chamber, it produces a clearance 100 between the front surface of the crystalline lens and the back surface of the optical part 1.

The optical part 1 makes contact with the crystalline lens 2 at the boundary portion between the optical part 1 and the support part 2, as shown in FIG. 2. This portion, formed with the grooves 4, contributes to a reduction in contact area with the crystalline lens and allows to the aqueous humor to flow in the clearance 100.

The aqueous humor that flowed in the clearance 100 passes through the fine pores 3 formed in the vicinity of the center of the optical part 1 into the anterior chamber. This makes it possible to cause fresh aqueous humor generated in or around the ciliary body to spread over the front surface of the crystalline lens and flow in the anterior chamber. Thereafter, when the aqueous humor in the clearance 100 flows in the anterior chamber through the fine pores 3 formed in the vicinity of the center of the optical part 1, the aqueous humor will be circulated by convection in the anterior chamber and then flow out from the angle between the iris and the cornea through a Schlemm's canal. Consequently, the aqueous humor can flow in the same way as before the operation. This makes it possible to suppress ophthalmic diseases (cataract, corneal edema, and others) which would be caused by preventing of the aqueous humor flow by the intraocular lens placed in the posterior chamber.

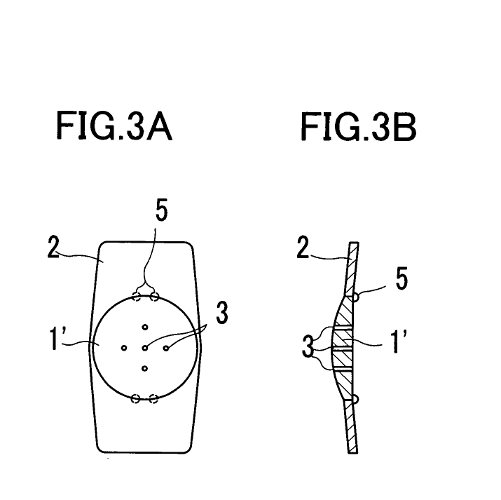

Next, an intraocular lens in a second embodiment of the present invention is explained with reference to FIG. 3. In this embodiment, elements constituting the intraocular lens having the same functions as those in the first embodiment are given the same numerals and therefore explanations thereof are omitted.

The intraocular lens in FIG. 3, having an optical part 1′ whose back surface is flat, is of a plano-convex shape instead of the meniscus shape. When such intraocular lens of the plano-convex shape is placed in the posterior chamber, the back surface of the optical part 1′, particularly, the center and its vicinity of the back surface tends to make contact with the front surface of the crystalline lens. To avoid such inconvenience, the intraocular lens is provided, on the back surface, with protrusions 5 as shown in FIGS. 3A (a plan view) and 3B (a sectional view). The protrusions 5 are interposed between the optical part 1′ and the crystalline lens, preventing the optical part 1′ from making contact with the crystalline lens. It is to be noted that the protrusions 5 are made of the same material as the optical part 1′. In the case of producing an intraocular lens from a foldable material, the protrusions 5 have to be formed at positions so as not to interfere with a folding operation. In the case of for example the intraocular lens shown in FIG. 3, this lens is folded in parallel to the longitudinal direction in many cases, namely, along a longitudinal axis line dividing the intraocular lens into two. Accordingly, as shown in FIG. 3, the protrusions 5 are preferably formed at positions off the axis line along which the lens is folded.

The above structure including the protrusions 5 makes it possible to place the intraocular lens shown in FIG. 3 in the posterior chamber in a reduced contact area with the crystalline lens and also to cause the aqueous humor to flow to the center and its vicinity of the front surface of the crystalline lens. Furthermore, the intraocular lens in this embodiment allows the aqueous humor having flowed to the center and its vicinity of the front surface of the crystalline lens to further flow in the anterior chamber through the fine pores 3 in the same manner as in the intraocular lens of FIG. 1.

It is to be noted that the protrusions 5 in the present embodiment are arranged in the boundary between the optical part 1′ and the support part 2, but not limited thereto. Note, however, that the protrusions 5 have to be formed on the back surface of the intraocular lens at positions where the protrusions 5 will not deteriorate the optical characteristics of the optical part 1′ and can prevent the center and its vicinity of the back surface of the optical part 1′ from making contact with the center and its vicinity of the front surface of the crystalline lens; for example, at positions slightly nearer the optical part 1′ or in the support part 2 outside the optical part 1′.

Moreover, the protrusions 5 may be formed in a biconvex intraocular lens or a meniscus intraocular lens.

Further, in the case of the intraocular lens such as the meniscus lens of which a contact portion with the crystalline lens is the optical part and its vicinity, such lens may include the contact portion previously formed with projections and depressions.

As described above, according to the present invention, the intraocular lens can keep a good flow of aqueous humor even when the intraocular lens is placed in the posterior chamber. The intraocular lens can also achieve a reduction in contact area with the crystalline lens.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. An intraocular lens which is placed between an iris and a crystalline lens, the intraocular lens including:
an optical part which has a predetermined refractive power, the optical part being larger in diameter than a diameter of a pupil and including a fine pore which is formed through the optical part and arranged within a region centering an optical center of the optical part corresponding to a pupil area; and
a support part which holds the optical part in an eye.

2. The intraocular lens according to claim 1, wherein the fine pore is of an inner diameter determined to allow aqueous humor to pass therethrough and maintain optical characteristics of the optical part.

3. The intraocular lens according to claim 2, wherein the inner diameter of the fine pore is in a range of 0.01 μm to 1 mm.

4. The intraocular lens according to claim 1, wherein at least one of the optical part and the support part is provided with a groove in a portion which makes contact with the crystalline lens when the intraocular lens is placed in the eye.

5. The intraocular lens according to claim 4, wherein the groove is formed in a position and direction determined to allow the aqueous humor to flow toward the fine pore.

6. The intraocular lens according to claim 1, wherein at least one of the optical part and the support part is provided with a protrusion in a portion which makes contact with the crystalline lens when the intraocular lens is placed in the eye.

7. An intraocular lens which is placed between an iris and a crystalline lens, the intraocular lens including:
an optical part which has a predetermined refractive power, the optical part being larger in diameter than a diameter of a pupil and including a fine pore which is formed through the optical part and arranged within a region centering an optical center of the optical part corresponding to a pupil area, and the fine pore being of an inner diameter determined to allow aqueous humor to pass therethrough and maintain optical characteristics of the optical part; and
a support part which holds the optical part in an eye.

8. The intraocular lens according to claim 7, wherein at least one of the optical part and the support part is provided with a groove in a portion which makes contact with the crystalline lens when the intraocular lens is placed in the eye.

9. The intraocular lens according to claim 7, wherein at least one of the optical part and the support part is provided with a protrusion in a portion which makes contact with the crystalline lens when the intraocular lens is placed in the eye.
